(19) United States
(12) Patent Application Publication
(10) Pub. No.: US 2026/0158513 A1
(43) Pub. Date: Jun. 11, 2026

(54) DEVICE FOR CLEANING AN OPTICAL SURFACE OF AN OPTICAL SENSOR, DETECTION SYSTEM AND VEHICLE

(71) Applicant: VALEO SYSTEMES D'ESSUYAGE, La Verriere (FR)

(72) Inventors: Yoann DOLLE, La Verriere (FR); William TERRASSE, La Verriere (FR); Denis THEBAULT, La Verriere (FR)

(73) Assignee: VALEO SYSTEMES D'ESSUYAGE, La Verriere (FR)

(21) Appl. No.: 19/127,164

(22) PCT Filed: Oct. 30, 2023
(86) PCT No.: PCT/EP2023/080249

§ 371 Date: May 5, 2025

(30) Foreign Application Priority Data
Nov. 4, 2022 (FR) FR2211484

(51) Int. Cl. B05B 12/32; B05B 1/14; B60S 1/52; G01S 7/497

(52) U.S. Cl. CPC B05B 12/32; B05B 1/14; B60S 1/52; G01S 2007/4977

(57) ABSTRACT

The invention proposes a device for cleaning an optical surface of an optical sensor of a vehicle. The device includes at least one segment in the form of an arc of a circle having a cleaning fluid inlet, at least one cleaning fluid circulation channel, able to be supplied with cleaning fluid via the cleaning fluid inlet, the channel being delimited by a base and a cover, at least one nozzle for diffusing cleaning liquid towards the optical surface from the fluid circulation channel. The at least one nozzle includes a deflector capable of deflecting the jet of cleaning fluid at a certain angle towards the optical surface, the cover having a thickness, and the deflector being at least partially within the thickness of the cover. The deflector is better protected. The invention also relates to a detection system and to a vehicle.

### TECHNICAL FIELD

The invention relates to a device for cleaning an optical surface of an optical sensor of a vehicle, to a detection system comprising such a cleaning device and to a vehicle comprising such a detection system.

### BACKGROUND OF THE INVENTION

Motor vehicles are being increasingly fitted with optical elements, such as optical position sensors. The function of the optical position sensors is to gather information about the area surrounding the vehicle, in particular to assist the driver in driving and/or maneuvering this vehicle. To this end, an optical sensor is commonly installed on the vehicle so as to collect information about the area surrounding the vehicle. However, such optical sensors are particularly exposed to dirt such as dirty water, dust or other types of spray. This dirt hinders the transmission and reception of information and can disrupt the operation of the optical sensor, or even stop it from operating.

The use of devices for cleaning an optical surface of optical elements so as to remove this dirt from them has been proposed. These cleaning devices spray a jet of cleaning fluid onto the optical surface of the optical elements. The jet is oriented toward the optical surface by nozzles of the cleaning devices.

The disadvantage of these devices is that the nozzles are subject to degradation during the process of manufacturing and assembling the devices.

There is therefore a need for a device for cleaning an optical surface of an optical sensor that is more robust

### SUMMARY OF THE INVENTION

The aim of the invention is to propose a device for cleaning an optical surface of an optical sensor that is more robust.

To this end, the invention proposes a device for cleaning an optical surface of an optical sensor of a vehicle, the device comprising at least one segment in the form of a circular arc having a cleaning fluid inlet, at least one cleaning fluid circulation channel that can be supplied with cleaning fluid by the cleaning fluid inlet, the channel being delimited by a base and a cover, at least one nozzle for spraying cleaning liquid toward the optical surface from the fluid circulation channel, the at least one nozzle having a duct for letting the cleaning fluid out through the cover and a deflector that can deflect the jet of cleaning fluid by a certain angle toward the optical surface, the deflector being at least partially within the cover. More specifically, the cover has a thickness and the deflector is at least partially within the thickness of the cover.

According to a variant, the deflector is embedded within the cover. More specifically, the deflector is embedded within the thickness of the cover.

According to a variant, the cover has a cavity that is open toward an upper face of the cover, the duct opening into the cavity and the deflector being a wall of the cavity.

According to a variant, the wall of the cavity forming the deflector is inclined with respect to the normal to the cover by an angle at which the jet of cleaning fluid is deflected toward the optical surface.

According to a variant, the cavity has another wall facing the wall forming the deflector, said other wall being inclined with respect to the normal to the cover by an angle greater than the angle of inclination of the wall forming the deflector.

According to a variant, the at least one segment comprises a plurality of nozzles with a deflector, the deflectors being able to deflect the jet of cleaning fluid by a first angle or another angle that is different from the first angle toward the optical surface or are able to deflect the jet of cleaning fluid by a given angle toward the optical surface.

According to a variant, the nozzle duct follows a normal to the cover or is inclined with respect to the normal to the cover.

According to a variant, the fluid outlet duct opens into the circulation channel through a stud on the cover.

According to a variant, the at least one segment further comprises at least one lug for fastening the device to the vehicle, the one or more fastening lugs are borne by the cover.

The invention also relates to a detection system comprising an optical sensor of a vehicle and the cleaning device as described above, the device being configured to clean the optical surface of the sensor.

According to a variant, the sensor has a cylindrical optical surface, the nozzles of the device being designed to direct the jet of cleaning fluid at different angles onto the optical surface.

The invention also relates to a vehicle comprising the system as described above.

All of the preferred embodiments and all of the advantages of the cleaning device according to the invention can be transferred, mutatis mutandis, to the present detection system and vehicle, and vice versa. The different embodiments may be taken in combination or considered in isolation.

### BRIEF DESCRIPTION OF DRAWINGS

Further features and advantages of the present invention will become apparent from reading the following detailed description, for the understanding of which reference will be made to the appended figures, in which:

FIG. 1 shows a view of a cleaning system and device according to the invention;

FIG. 2 shows a detail view of a segment of the cleaning device;

FIG. 3 shows a perspective view of a detail of the device in FIG. 1; and

FIG. 4 shows the segment of the device in FIG. 1 in cross section.

The drawings in the figures are not to scale. Similar elements are generally denoted by similar references in the figures. In the context of this document, identical or similar elements may bear the same references. Furthermore, the presence of reference numbers or letters in the drawings cannot be considered limiting, including when these numbers or letters are indicated in the claims.

### DETAILED DESCRIPTION OF THE INVENTION

The invention proposes a device for cleaning an optical surface of an optical sensor of a vehicle. The device comprises at least one segment in the form of a circular arc having a cleaning fluid inlet, at least one cleaning fluid circulation channel that can be supplied with cleaning fluid by the cleaning fluid inlet, the channel being delimited by a base and a cover. The segment also has at least one nozzle for spraying cleaning liquid toward the optical surface from the fluid circulation channel, the at least one nozzle having a duct for letting the cleaning fluid out through the cover and a deflector that can deflect the jet of cleaning fluid by a certain angle toward the optical surface. The deflector is at least partially within the cover. More specifically, the cover has a thickness and the deflector is at least partially within the thickness of the cover. This enables the deflector to protrude out from the cover to a lesser extent. The nozzle bearing the deflector is subject to degradation to a lesser extent, thus making the cleaning device more robust.

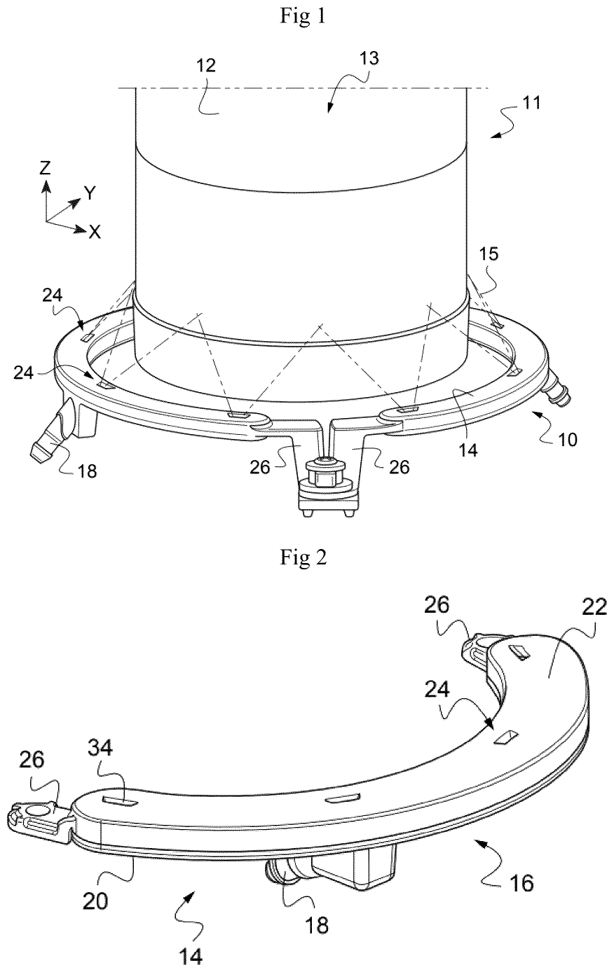

FIG. 1 shows a cleaning device 10. The cleaning device 10 may in particular be used in a detection system 11 of a vehicle comprising an optical sensor 12. The optical sensor 12 makes it possible to gather information about the position and the area surrounding the motor vehicle, in particular to assist the driver in driving and/or maneuvering this vehicle. The optical sensor 12 is installed on the vehicle so as to collect information about the area to the front, rear and/or side of the vehicle: the optical sensor 12 is for example installed at the front end and/or at the rear end. The optical sensor 12 is for example a LIDAR, which stands for “light detection and ranging” or “laser imaging, detection, and ranging”.

The sensor 12 interacts with the surrounding area through an optical surface 13. This may be a protective surface between the optical element and the surrounding area. For example, it may be the surface of a pane fitted between the sensor and the surrounding area, or a surface of a casing that encloses a sensor (such as a face of a LIDAR casing). The surface may be opaque (to the visible wavelengths). The surface may be transparent to the transmission and reception wavelengths of the sensor 12. It is also possible to envision a plurality of sensors interacting with the surrounding area through a single optical surface.

The shape of the optical surface 13 may vary according to the location and use of the sensor 12 in the vehicle and depending on the available space around the sensor. The optical surface 13 may have some portions that are rounded and others that are rectilinear. According to FIG. 1, the optical surface 13 has a cylindrical shape.

The device 10 comprises at least one segment 14. The device may comprise a plurality of segments 14, specifically two segments or more. According to FIG. 1, two segments are shown by way of example. For example, the segments 14 may be configured to form a circular arc. A circular arc is a portion of a curve that is delimited by two points of this curve; a circular arc is a portion of the circumference of a circle with a center and a radius. The circular arc defines an axial direction Z that passes through the center of the circular arc, a radial direction Y that follows a radius of the circular arc, and a tangential direction X that is tangential to the circular portion of the circular arc. The circular arc may extend in a plane, i.e. a two-dimensional space, but may also be shaped such that the circular arc is partially in a plane and extends in three dimensions. Possibly, at least some of the segments are in the form of a circular arc, such as the segments in FIGS. 1 and 2. The optical surface 13 is at least partially surrounded by the device 10 (at least in the portions by means of which the one or more sensors 12 interact with the surrounding area). The device 10 may have a closed or open shape. The device 10 may have a circular overall shape with the directions X, Y, Z defined above. It is possible to envision that the segments 14 form an annular structure. The annular structure (of 360°) may have two segments (each segment representing 180°), or three segments (each segment representing 120°), or four segments (each segment representing 90°).

FIG. 2 shows an example of a segment 14. The segment 14 has a shape that is elongate between two ends. The segment 14 is configured to orient a jet 15 of cleaning fluid toward the optical surface 13. The segment is configured to follow the shape of the optical surface 13. The segment 14 may have a circular-arc shape, as defined above. The circular arc formed by the segment 14 may extend in three dimensions, and the segment 14 may have a slope between its ends. In a top view, the segment 14 is still a circular arc. The shape of the segment may also have sections with other shapes, such as rectilinear shapes or any shape, depending on the area surrounding the optical surface 13. The segment 14 is adapted to the available space around the optical surface 13. The segments 14 may have a shape that differs from one segment to the next. This makes it possible to adapt it to the shape of, and to the area surrounding, the optical surface 13.

The segment 14 has a cleaning fluid circulation channel 16. The channel 16 in the segment 14 is a flow duct with a hollow and elongate form, enabling passage of the fluid for cleaning the optical surface 13. The channel 16 follows the shape of the segment 14. The channel 16 extends over at least part of the length of the segment 14. A channel 16 defines a flow duct specific to each segment 14. If the device 10 is provided with a plurality of segments, the respective channels 16 are independent of one another. This makes the device 10 easier to maintain.

The segment 14 comprises a cleaning fluid inlet 18. The inlet 18 is connected to a cleaning fluid distribution network and makes it possible to supply cleaning fluid to the channel 16. Each segment 14 of the device 10 comprises its own fluid inlet 18; fluid is thus supplied to each of the segments 14 independently. The inlet 18 may extend along the axis Z, but another orientation, such as an angled orientation, may be envisioned in order to adapt to the area surrounding the sensor. The segment 14 comprises a base 20 and a cover 22 delimiting the cleaning fluid circulation channel 16 between them.

The segment 14 further comprises at least one nozzle 24 for spraying cleaning fluid toward the optical surface. The channel 16 in each segment 14 thus makes it possible to distribute cleaning fluid to the one or more fluid spray nozzles 24. Four nozzles 24 are shown by way of example on the segment 14 in FIG. 2. The segments have a number of nozzles 24 that is specific to them, depending on the location of the segments 14 with respect to the optical surface 13 and with respect to the portion of the optical surface 13 that is to be cleaned.

Similarly, the nozzles 24 are distributed over each segment 14 depending on the portion of the optical surface 13 that is to be cleaned.

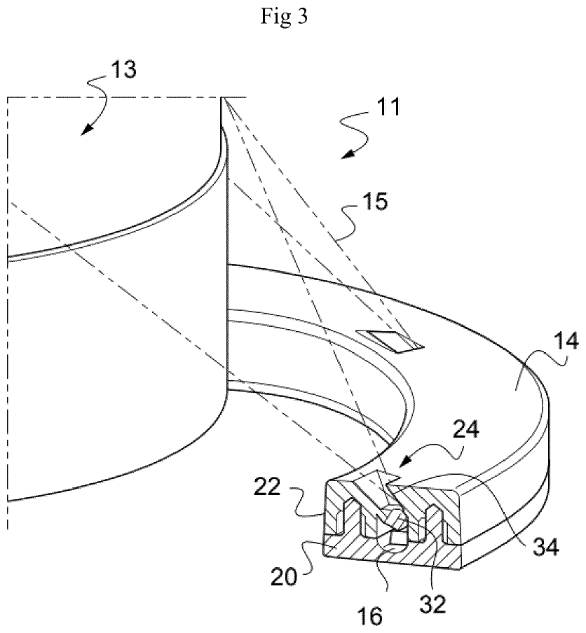

FIG. 3 shows a perspective view of a detail of the device 10. The segment 14 is shown in perspective and in section. The at least one nozzle 24 of the segment 14 has a duct 32 for letting the cleaning fluid out and a deflector 34 that can deflect the jet of cleaning fluid by a certain angle toward the optical surface. The duct 32 enables the cleaning fluid to exit the channel 16 through the cover and to be directed toward the deflector 34. The deflector 34 is a wall, i.e. a surface, making it possible to orient a jet of fluid. The deflector 34 is at least partially within the cover. The deflector 34 is not only integrated in the cover, but is also at least partially within the cover. The cover has a thickness and the deflector 34 is at least partially within the thickness of the cover 22. The deflector extends at least partly inside the cover 22. The deflector 34 extends at least partially (or partly) within the thickness of the cover. The deflector 34 extends at least partly within the thickness of the cover 22 and possibly partly outside the cover 22. The deflector 34 extends at least partly inside the cover 22 and possibly partly outside the cover 22. This makes it possible to protect the deflector 34 by making it protrude from the cover 22 to a lesser extent. This makes it possible to protect the at least one nozzle 24 while the segment 14 is being transported until it is mounted on a vehicle. This also makes it possible to protect any operator manipulating the segment 14 by reducing the size of the nozzle and therefore the size of any sharp edge of the at least one nozzle 24. Preferably, the deflector 34 is embedded within the cover 22. The deflector 34 is completely within the cover 22. The deflector 34 is embedded within the thickness of the cover 22. The deflector 34 is entirely embedded within the thickness of the cover 22. The deflector extends solely (entirely) inside the cover 22. The deflector 34 extends solely (entirely) within the thickness of the cover. The cover 22 is planar at the deflector 34. The deflector does not protrude from the upper face of the cover 22. By being absent from the upper face of the cover 22, the deflector 34 is even further protected. This makes it possible to protect the at least one nozzle 24 while the segment 14 is being transported until it is mounted on a vehicle. This also makes it possible to protect any operator manipulating the segment 14 against a potential injury on a sharp edge of the at least one nozzle 24. This also makes it easier to define the packaging for transporting the segment 14. In addition, this makes it possible to dispense with any protection on the device 10 aimed at protecting the integrity of the nozzles 24.

According to FIG. 3, the channel 16 is delimited by the cover 22 fastened to the base 20. The channel 16 is supplied with cleaning liquid from the inlet 18. The cleaning liquid is intended to circulate in the channel 16 and to exit the channel via the duct 32 through the cover 22. The liquid is sprayed in the form of a jet 15 toward the optical surface 13. The cleaning liquid is sprayed by the deflector 34 of the nozzle 24, which is shown as embedded within the cover 22 by way of example-it being possible for the deflector 34 to partly protrude from the cover 22. The deflector 34 is a wall defining the angle by which the jet 15 is deflected toward the optical surface 13. The angle of inclination of the wall may be determined according to the portion of the optical surface 13 to be cleaned.

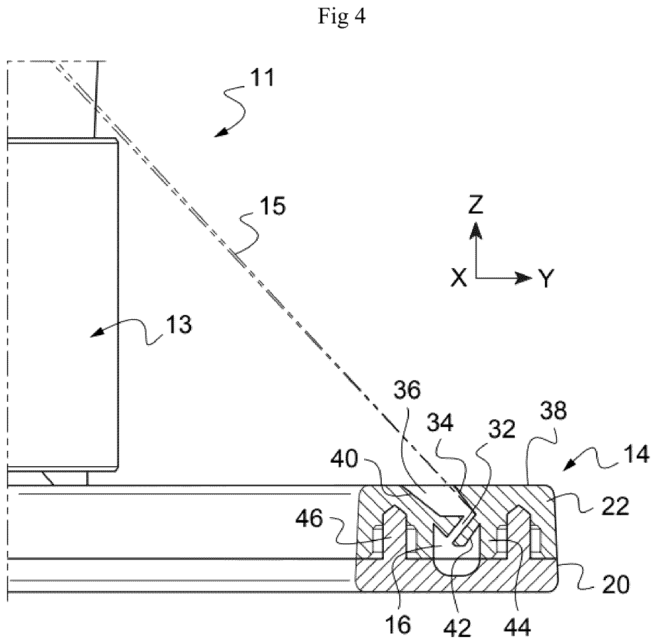

FIG. 4 shows the segment 14 of the device 10 in cross section. The cover 22 may have a cavity 36 that is open toward the upper face 38 of the cover 22. The duct 32 opens into the cavity 36. The cavity 36 is a hollow portion of the upper face 38 of the cover 22. The duct 32 enables the cleaning liquid to be conveyed from the channel 16 inside the segment 14 as far as the cavity 36 toward the outside of the segment 14. The deflector 34 is a wall of the cavity 36. The angle of inclination of the—preferably planar—wall makes it possible to orient the jet 15. The deflector 34 is at least partially within the cover 22 in the sense that the wall defining the deflector 34 extends partly within the thickness of the cover 22, along the hollow portion defining the cavity 36, and partly outside the cover 22, by protruding from the upper face 38 of the cover 22. The protruding part of the deflector 34 is smaller in the sense that part of the deflector 34 is within the cover 22 and enables the jet 15 to be oriented at a certain angle from the inside (the thickness) of the cover 22. This makes it possible to protect the deflector 34—and therefore the nozzle 24—during transport and mounting of the cover.

Preferably, and according to FIG. 4, the deflector 34 is embedded within the cover 22 in the sense that the wall defining the deflector 34 extends within the thickness of the cover 22, along the hollow portion defining the cavity 36, without protruding outside the cover 22.

The entire wall of the deflector 34 is within the cover 22 and enables the jet 15 to be oriented at a certain angle from solely the inside (the thickness) of the cover 22. This makes it possible to even further protect the deflector 34—and therefore the nozzle 24—during transport and mounting of the cover. This avoids any injury to an operator because there is no sharp edge protruding from the cover 22.

The wall of the cavity 36 forming the deflector 34 is inclined with respect to the normal to the cover 22 by an angle at which the jet of cleaning fluid is deflected toward the optical surface. The normal to the cover 22 may follow the axis Z. The wall is inclined by an angle in the counterclockwise direction in FIG. 4. The wall of the cavity 36 defining the deflector 34 faces the optical surface 13. The greater the angle of inclination, the more the jet of cleaning liquid is oriented toward the bottom of the optical surface 13—and vice versa. In the case in which the segment 14 has a plurality of nozzles 24, the respective deflectors 34 can deflect the flow of cleaning fluid by a first angle or another angle that is different from the first angle toward the optical surface. The angle of inclination of each deflector 34 may be different from the others. It is possible to envision that some of the deflectors deflect the jet by a first angle and the rest of the deflectors deflect the jet by a second angle that is different from the first. For example, in FIG. 2, two of the four deflectors deflect the jet by a first angle and the other two deflectors deflect the jet by a second angle that is different from the first angle. It is thus possible to have some of the nozzles 24 orienting the jet toward the top of the optical surface and some other of the nozzles 24 orienting the jet toward the bottom of the optical surface. Alternatively, all the deflectors of one segment can deflect the jet of cleaning fluid by a given angle toward the optical surface. Within the device 10, a plurality of segments orient the one or more jets at angles specific to each nozzle 24.

The cavity 36 may have another wall 40 facing the wall forming the deflector 34. The wall 40 is inclined with respect to the normal to the cover 22 by an angle greater than the angle of inclination of the wall forming the deflector 34. This enables the jet of cleaning fluid not to be impeded when it is sprayed toward the optical surface 13.

The cleaning fluid outlet duct 32 is positioned within the cover 22 (or in other words within the thickness of the cover) so as to cause the fluid to exit into the cavity 36 in order to orient it toward the deflector 34. The duct may follow a normal. The duct 32 thus follows the axis Z. This makes the cover 22 easier to manufacture, for example by molding.

Alternatively, the duct 32 may be inclined with respect to the normal to the cover, according to FIG. 4. The duct 32 is thus inclined with respect to the axis Z. This makes it possible to lengthen the duct 32 and to reinforce the cover 22.

The fluid outlet duct 32 may open into the channel 16 through a stud 42 on the cover. The stud 42 is an overthickness of the internal face of the cover 22, oriented toward the inside of the channel 16. This enables the length of the duct 32 to be extended. This makes it possible to better guide the jet of fluid at the outlet of the channel 16. Thus, the jet of fluid is better formed at the outlet of the cover 22. This enables the thickness of the cover 22 to be reduced without otherwise adversely affecting the quality of the jet formed by the nozzle 24.

The cover 22 may be fastened to the base 20 by welding, laser welding, ultrasonic welding, push-fitting, clip-fastening, adhesive bonding or screw-fastening. The cover 22 may comprise ribs 44 stressing the base 20 of the channel 16. This makes it possible to improve the fluidtightness of the segments 14, thereby preventing cleaning fluid losses. More specifically, the channel 16 is between two ribs 44; the ribs 44 and the channel 16 of the segment 14 may be concentric in the form of a circular arc. The base 20 may also have ribs 46 stressing the cover 22 in order to reinforce the fluidtightness. The internal and external perimeter of the cover 22 may also rest on the perimeter of the base 20 so as to further enhance the fluidtightness of the segments.

The segment 14 also has at least one lug 26 for fastening the device 10 to the vehicle, which is shown in FIGS. 1 and 2. The one or more lugs 26 make it possible to position the segment 14 within the vehicle with respect to a support. The one or more lugs 26 enable precise positioning of the segment 14 with respect to the optical surface 13 so that the at least one nozzle 24 of the segment orients the jet 15 of cleaning fluid onto the part of the optical surface 13 that is dedicated thereto. The segment 14 may have two lugs 26 for fastening the device 10 to the vehicle. According to FIG. 2, a lug 26 is provided at each end of the segment 14 of elongate shape. This ensures the stability of the segment 14 and the precise positioning of the one or more nozzles 24 with respect to the optical surface 13.

The at least one fastening lug 26 and the at least one nozzle 24 may be borne by the cover 22. Thus, the same component of the device 10—the cover 22—supports the one or more nozzles 24 and the one or more lugs 26. The relative position of the one or more nozzles 24 and of the one or more lugs 26 is determined from the design and manufacturing of the cover 22 (for example by molding). There is no intermediate adjustment between the position of the lugs 26 and the position of the nozzles 24. This makes it possible to reduce the chain of dimensions between the fastening of the segment 14 to the vehicle and the relative position of the one or more nozzles 24 with respect to the optical surface 13. The one or more lugs 26 enable fastening to the vehicle via a support. This support can also support the position sensor 12—improving the precision of the position of the nozzles 24.

The invention also relates to the detection system 11 shown in FIG. 1, comprising the optical sensor 12 of a vehicle and the cleaning device 10. The device 10 is configured to clean the optical surface 13 of the optical sensor. According to one embodiment, the sensor may have a cylindrical optical surface 13, the nozzles 24 of the device 10 being designed to direct the jet of cleaning fluid at different angles onto the optical surface.

The invention also relates to a vehicle comprising the detection system 11. Since the deflector 34 of the at least one nozzle 24 is at least partially within the cover 22, the deflector is better protected against degradation, thereby ensuring effective cleaning of the optical surface 13 of the sensor 12. This improves the driving of the vehicle.

The present invention has been described in relation to specific embodiments, which have purely illustrative value and should not be considered limiting. In general, it will be obvious to a person skilled in the art that the present invention is not limited to the examples illustrated and/or described above.

1. A device for cleaning an optical surface of an optical sensor of a vehicle, the device comprising at least one segment in the form of a circular arc having
a cleaning fluid inlet,
at least one cleaning fluid circulation channel that can be supplied with cleaning fluid by the cleaning fluid inlet, the channel being delimited by a base and a cover,
at least one nozzle for spraying cleaning liquid toward the optical surface from the fluid circulation channel, the at least one nozzle nozzle having a duct for letting the cleaning fluid out through the cover and a deflector that can deflect the jet of cleaning fluid by a certain angle toward the optical surface, and the cover having a thickness and the deflector being at least partially within the thickness of the cover.

2. The device as claimed in the claim 1, wherein the deflector is embedded within the thickness of the cover.

3. The device as claimed in claim 1, wherein the cover has cavity that is open toward an upper face of the cover, the duct opening into the cavity and the deflector being a wall of the cavity.

4. The device as claimed in claim 3, wherein the wall of the cavity forming the deflector is inclined with respect to the normal to the cover by an angle at which the jet of cleaning fluid is deflected toward the optical surface.

5. The device as claimed in claim 3, wherein the cavity has another wall facing the wall forming the deflector, the other wall being inclined with respect to the normal to the cover by an angle greater than the angle of inclination of the wall forming the deflector.

6. The device as claimed claim 1, wherein the at least one segment includes a plurality of nozzles with a deflector, the deflectors being able to deflect the jet of cleaning fluid by a first angle or another angle that is different from the first angle toward the optical surface or are able to deflect the jet of cleaning fluid by a given angle toward the optical surface.

7. The device as claimed in claim 1, wherein the nozzle duct follows a normal to the cover or is inclined with respect to the normal to the cover.

8. The device as claimed in claim 1, wherein the fluid outlet duct opens into the circulation channel through stud on the cover.

9. The device as claimed in claim 1, wherein the at least one segment includes at least one lug for fastening the device to the vehicle, the one or more fastening lugs are borne by the cover.

10. A detection system comprising an optical sensor of a vehicle and a cleaning device, the device being configured to clean an optical surface of the sensor, the device includes at least one segment in the form of a circular arc having a cleaning fluid inlet, at least one cleaning fluid circulation channel that can be supplied with cleaning fluid by the cleaning fluid inlet, the channel being delimited by a base and a cover, at least one nozzle for spraying cleaning liquid toward the optical surface from the fluid circulation channel, the at least one nozzle having a duct for letting the cleaning fluid out through the cover and a deflector that can deflect the jet of cleaning fluid by a certain angle toward the optical surface, and the cover having a thickness and the deflector being at least partially within the thickness of the cover.

11. The system as claim 10, wherein the sensor has a cylindrical optical surfaces, the nozzles nozzles of the device being designed to direct the jet of cleaning fluid at different angles onto the optical surface.

12. A vehicle comprising a detection system, claimed the detection system includes an optical sensor of the vehicle and a cleaning device, the device being configured to clean an optical surface of the sensor, the device includes at least one segment in the form of a circular arc having a cleaning fluid inlet, at least one cleaning fluid circulation channel that can be supplied with cleaning fluid by the cleaning fluid inlet, the channel being delimited by a base and a cover, at least one nozzle for spraying cleaning liquid toward the optical surface from the fluid circulation channel, the at least one nozzle having a duct for letting the cleaning fluid out through the cover and a deflector that can deflect the jet of cleaning fluid by a certain angle toward the optical surface, and the cover having a thickness and the deflector being at least partially within the thickness of the cover.
